(19) United States
(12) Patent Application Publication
(10) Pub. No.: US 2014/0172550 A1
(43) Pub. Date: Jun. 19, 2014

(54) ENGAGEMENT-BASED DYNAMIC PAYMENT AMOUNTS FOR PPC (PAY-PER-CLICK) ADVERTISEMENTS

(71) Applicant: MYLIKES, San Francisco, CA (US)

(72) Inventors: Bindu Priya REDDY, San Francisco, CA (US); Arvind SUNDARARAJAN, San Francisco, CA (US)

(73) Assignee: MYLIKES, San Francisco, CA (US)

(21) Appl. No.: 14/183,501

(22) Filed: Feb. 18, 2014

Related U.S. Application Data
(63) Continuation-in-part of application No. 13/044,488, filed on Mar. 9, 2011.
(60) Provisional application No. 61/339,808, filed on Mar. 10, 2010.

(51) Int. Cl. G06Q 50/00; G06Q 30/02

(52) U.S. Cl. CPC G06Q 50/01; G06Q 30/0246; G06Q 30/0273
USPC 705/14.45

(57) ABSTRACT

A plurality of advertisements are associated with PPC (pay-per-click) payment amounts paid to third-party publishers for referrals. The PPC payment amount is based on a level of engagement for a particular user with a particular advertisement. As a result, each instance of an advertisement impression can lead to a varying PPC payment amount. The PPC payment amounts are accumulated by the publisher that successfully induces user interactions with the plurality of advertisements through a social media platform.

### CROSS-REFERENCE TO RELATED APPLICATIONS

This application claims priority under 35 U.S.C. §120 as a continuation-in-part of U.S. patent application Ser. No. 13/044,488, filed on Mar. 9, 2011, and entitled SYSTEM AND METHOD FOR DETERMINING EARNINGS PER-CLICK FOR ADS PUBLISHED WITHIN A SOCIAL ADVERTISING PLATFORM, by Bindu Priya Reddy, et al., which in turn claims priority under 35 U.S.C. §119(e) to U.S. Prov. App. No. 61/339,808, filed on Mar. 10, 2010, the contents of both being hereby incorporated in their entirety.

### FIELD OF THE INVENTION

The invention relates generally to online advertising, and more specifically, to determining PPC (pay-per-click) earnings based on a level of engagement with an advertisement.

### BACKGROUND

Online advertising has increased in significance as the Internet has matured into a leading media source for consumers. Advertisements on web sites appear in, for example, banners, pop-ups, and search results. Under the traditional pay-per-click (PPC) model for advertising revenue on the Internet, a publisher earns a fixed amount of currency for each click on an advertisement provided by the publisher.

Social media provides a relatively newer platform for advertising to consumers on the Internet. The nature of social media is to customize the user experience in some automated ways. Users can build a following by publishing interesting or relevant content. For example, a Twitter account belonging to a large entity such as CNN can have millions of followers.

Problematically, a click-through on a hyperlink to an advertisement provides limited information regarding the effectiveness of the referral. Namely, users may abandon an advertisement immediately after the click. Some publishers are more highly regarded by their associates, so an advertisement can amount to an endorsement. These associates may not only click-through to an advertisement, but may also make a purchase due to the referral source and a particular message posted by the referral source about the advertisement. Some advertisements published by a referral source are more strongly endorsed than others, leading to better results for the advertiser.

What is needed is a robust technique to determine a PPC payment amount based on a level of engagement with an advertisement.

### SUMMARY

To meet the above-described needs, methods, computer program products, and systems for advertisements with dynamic PPC (Pay-Per-Click) payment amounts based on levels of engagement with advertisements.

In one embodiment, a plurality of advertisements are associated with PPC (pay-per-click) payment amounts paid to third-party publishers for referrals. The PPC payment amount is based on a level of engagement for a particular user with a particular advertisement. As a result, each instance of an advertisement impression can lead to a varying PPC payment amount. The PPC payment amounts are accumulated by the publisher that successfully induces user interactions with the plurality of advertisements through a social media platform.

In an embodiment, an advertisement provided for publication is distributed along with other content through the social media platform by the publisher (e.g., in a status feed or in individual messages sent to contacts). Once a user interacts with the advertisement by clicking, making purchases, or the like, a notification is sent to an advertisement server, or other tracker. A level of engagement of the user with respect to the advertisement is determined from one or more notifications, for each impression of the advertisement. A PPC payment amount from the multiple PPC payment amounts is correlated to the click based on the level of engagement with the user as compared against a baseline of other users for the same advertisement. The PPC payment amount can be stored in association with the publisher and added to a total.

Advantageously, compensation for referrals can be discriminated to incentivize better referral clicks.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for advertising on social media platforms with dynamic PPC (pay-per-click) payment amounts, according to one embodiment.

FIG. 2 is a more detailed block diagram illustrating an advertisement server of the system of FIG. 1, according to one embodiment.

FIG. 3 is an interaction diagram illustrating a communication sequence between components of the system of FIG. 1 for advertising on social media platforms with dynamic PPC payment amounts, according to one embodiment.

FIG. 4 is a high-level flow diagram illustrating a method for advertising on social media platforms with dynamic PPC payments amounts, according to one embodiment.

FIG. 5 is a more detailed flow diagram illustrating a step of serving PPC advertisements from advertisers to social media platforms in the method of FIG. 4, according to one embodiment.

FIG. 6 is a more detailed flow diagram illustrating a step of evaluating user click sequences to determine a level of engagement with advertisements in the method of FIG. 4, according to one embodiment.

FIG. 7 is a block diagram illustrating an exemplary computing device, according to one embodiment.

### DETAILED DESCRIPTION

Methods, computer program products, and systems for advertisements with dynamic PPC (pay-per-click) payment amounts based on levels of engagement are disclosed. For example, a famous dog breeder tweets a message to 500,000 followers with an embedded hyperlink stating “Finals for the national competition tomorrow . . . so you know what my dogs will be eating . . . http://www.purina.com/777395.” When the hyperlink is clicked by a user, an advertisement for dog food is shown with hyperlinks therein for more information, to chat with a sales representative, for directions to the nearest vendor, or to place an online order.

As used herein, the term PPC also refers to CPC (cost-per-click), click-throughs, earnings-per-click, or any other appropriate technique for rewarding user interactions with respect to an advertisement. Also, the term click is used for simplicity, but at times is also intended to include other user interactions such as hovering with a mouse, filling out a web form and making a purchase. Finally, the use of social media platforms, and in particular, social networking web sites, is intended to be illustrative and does not limit the application of the disclosed techniques to point-to-point messaging, e-mail, video conferencing, and other forms of electronic communications.

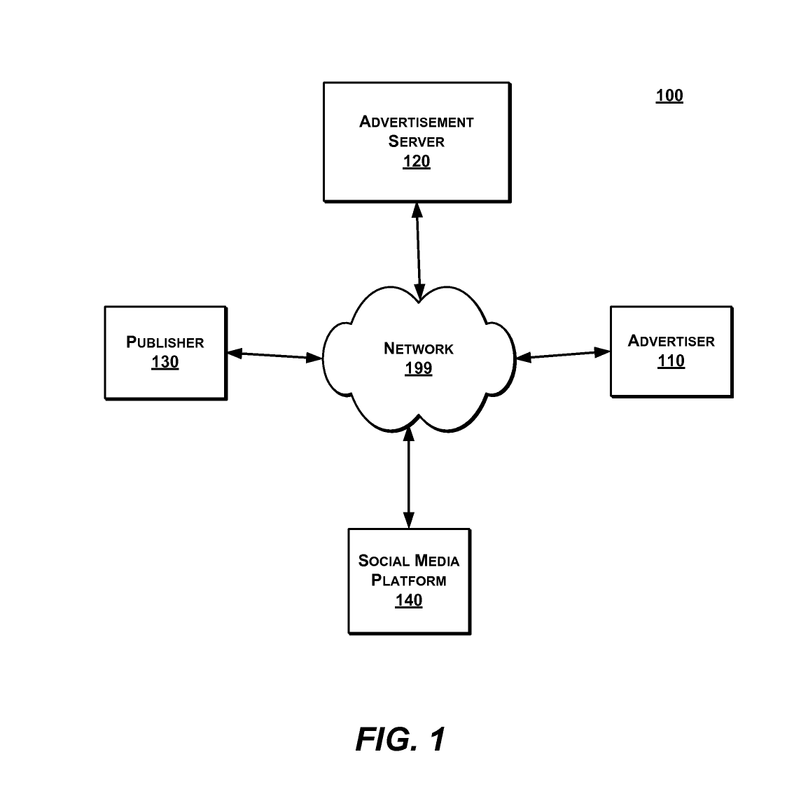

Systems for Dynamic PPC Payment Amounts (FIGS. 1-3)

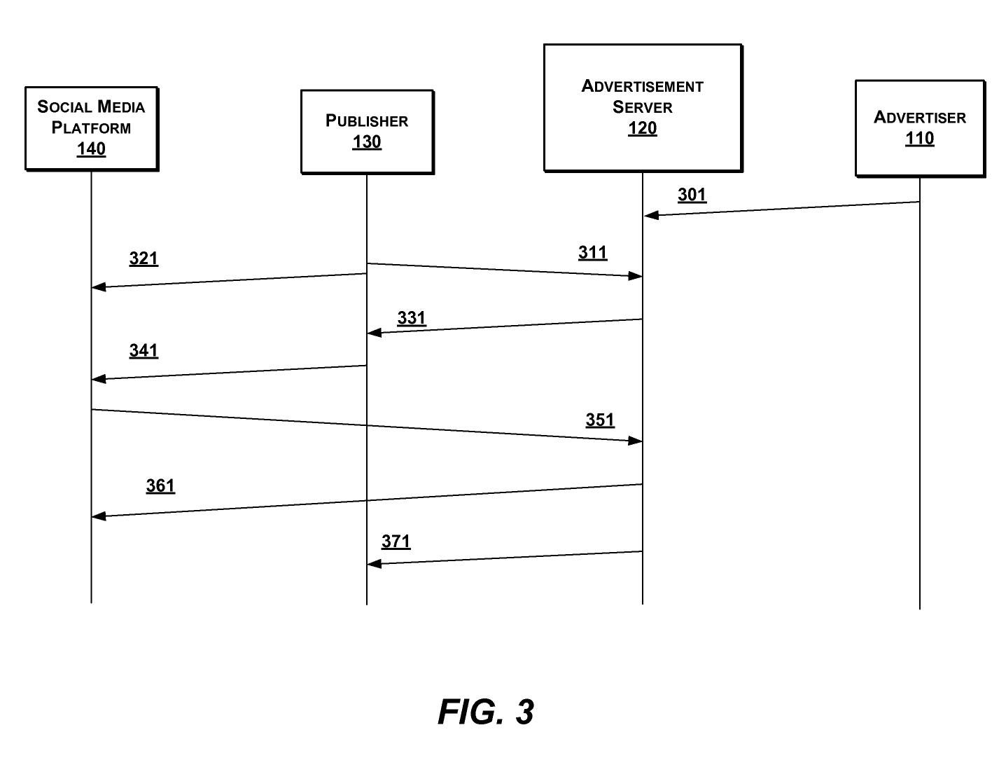

FIG. 1 is a high-level block diagram illustrating a system for advertising with dynamic PPC payment amounts based on levels of engagement, according to one embodiment. The system 100 includes an advertisement server 110, an advertiser 120, a publisher 130, a social media platform 140 and a termination point, each coupled in communication with a network 199. Other embodiments of the system 100 can include additional network components that are not shown in FIG. 1. For example, there can be network devices such as switches, routers, fire walls, proxy servers, and the like. Some of the components can be integrated into a single device, and additionally, some functions of components can be separated into an additional device. Interactions of the components are described more fully below with respect to FIG. 3.

The advertiser 110 can be an individual, a corporate entity, a manufacturer, a reseller, a distributor, an advertising executive, a product manager, a sponsor, an automated process, or the like, using a computing device to configure online advertisements through the advertisement server 120. The advertiser 120 can log-on and open account with the advertisement server 120. The advertiser 120 sets up an online advertising campaign and provides PPC payment amounts for each advertisement, including multiple PPC payment amounts for different levels of engagement with a particular advertisement. Other data values provided by the advertiser 120 include, for example, a daily overall client budget, a daily overall budget for each advertisement, a campaign budget, and termination points.

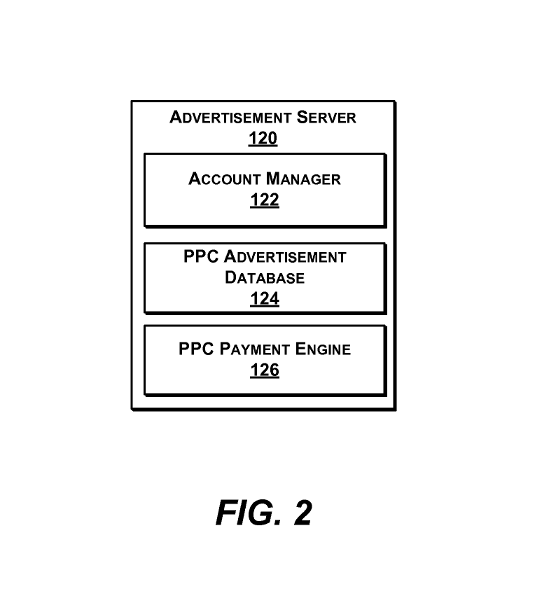

The advertisement server 120 can be a personal computer (PC), mobile device, server blade, a storage network, or any other computing devices discussed herein. In the embodiment of FIG. 1, the advertisement server 120 is an independent device and can be operated by an independent, third party entity. However, in other embodiments, the components are integrated, and can be owned and/or operated by the same party. For example, the advertisement server 120 can be operated by the social media platform 140. The advertisement server 120 stores advertisements provided by the advertiser 110, and all additional relevant data (e.g., identification information, termination points, on or more PPC payment amounts). For publication, a publisher 130 can receive advertisements from the advertisement server 120 for publication on the social media platform 140 in the form of code snippets (e.g., HTML code snippets), unique identifiers, embeddable images or video, and the like. In some embodiments, advertisements are served dynamically. Once an advertisement is selected, the advertisement server 120 tracks a click sequence of a user while interacting with the advertisement, and then credits the publisher 130 with a PPC payment amount corresponding to a level of engagement achieve by the interactions. More detailed embodiments of the advertisement server 120 are discussed in more detail below in association with FIG. 2.

The publisher 130 can be an individual, an entity, a group, a fan club, a celebrity, a blogger, or any other type of social networker, or automated process, using a computing device to publish advertisements provided by the advertisement server 120. In some embodiments, the publisher 130 establishes a social networking account with the social media platform 140 and the advertisement server 120. Advertisements are placed when the publisher 130 posts a status update, a blog entry, or other type of publication. For example, the publisher 130 can send a Twitter message to followers that includes a hyperlink to an advertisement for a movie. Advertisements can be more effective when related to publisher content, such as when a music band posts a status updated on a Facebook fan page that includes an image advertising a new CD. Also, the music band can post a video clip on Instagram or Vine that hyperlinks to a new music video associated with the CD. Ultimately, the publisher 130 is paid for referral clicks accumulated from users of the social media platform 140 that click on the advertisements of the publisher 130.

The social media platform 140 can be any network of electronically connected users and associates such as social media profile pages, e-mail, blogs, chats, video conferencing, and the like. Social media profile pages are established on Twitter, Facebook, Instagram, Likes.com, MySpace, Vine, YouTube, Google Circles, LinkedIn, and others. The social media platform 140 can include a status feed, a user profile page, messages distributed to individual users, text messages, video calls, and more. A user interaction can involve functionality that is part of the social media platform 140, such as liking a post, re-posting a status, re-tweeting a post, commenting on a post, and tagging a post.

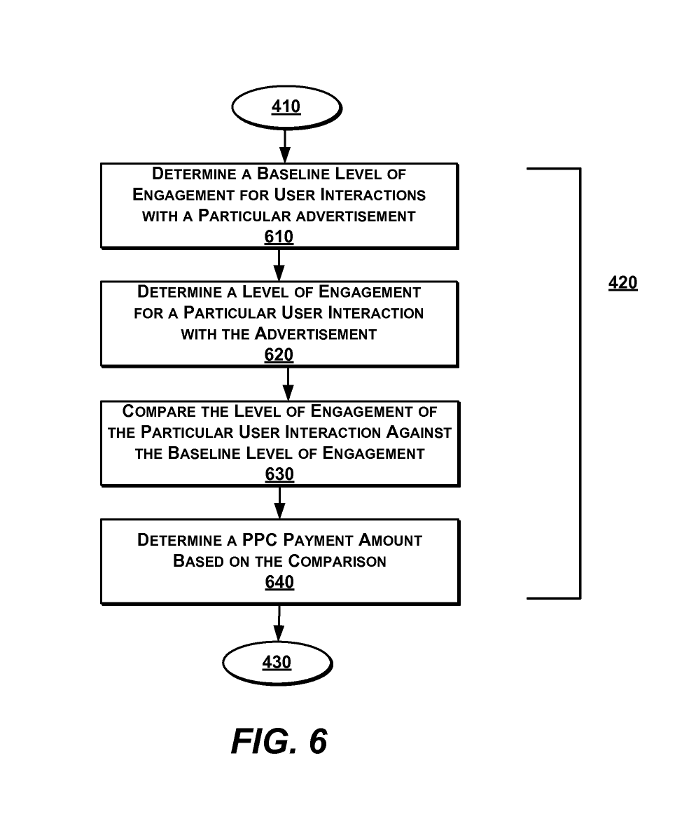

FIG. 2 is a more detailed block diagram illustrating the advertisement server 120 of the system 100 of FIG. 1, according to one embodiment. The advertisement server 120 includes an account manager 122, a PPC advertisement database 124, PPC payment engine 126. The components can be implemented in hardware, software, or a combination of both. One of ordinary skill in the art will understand that the components are only exemplary representations of functionality that can be combined or segregated into additional components. Further, other components can include an operating system, a communications port, and the like, as described in more detail below with respect to FIG. 6.

The account manager 122, in some embodiments, provides a user interface for managing various aspects of an account. For example, advertisers set up advertising campaigns by specifying a PPC payment amount along with other parameters such as a campaign budget, and termination points, to name a few. The PPC payment amounts for a particular advertisement can vary based on a level of engagement, as indicated by advertisers. In another example, publishers set up accounts for advertisement referrals. Publishers can log on to track metrics associated with PPC payments amounts. In one embodiment, metrics for levels of engagement for advertisements is provided. In other examples, publishers register social media platforms to allow direct or automated publication of advertisements.

The PPC advertisement database 124 (e.g., a relational database) stores advertisement content in a searchable format. Each advertisement can have a unique identifier such as a URL, or other custom code. The advertisement itself can be any digital format for text (e.g., a text string, Microsoft Word document, or PDF), images (e.g. GIF, JPG or BMP), video (e.g., MPG), or other multimedia. The PPC advertisement database 124 can also store PPC payment amounts associated with advertisements. When notified of a referral click on a social media platform, the PPC advertisement database 124 is searched to retrieve advertisement content.

The PPC payment engine 126 tracks how much money a publisher account has accumulated. In one embodiment, the PPC payment engine 126 receives notifications of user interactions associated with advertisements. One type of user interaction is a click on to a hyperlink of any suitable form. Other user interactions include hovering with a cursor, eye contact, filling out forms, making a purchase and registering. User interactions can be particular to social media platforms, such as re-tweeting a Twitter message. Each type of user interaction, for each separate advertisement, can have a specific PPC payment amount. The PPC payment engine 126 matches a user interaction with a PPC payment amount for each instance that an advertisement is severed to a user. In some implementations, the PPC payment amount is cumulative. In other implementations, the PPC payment amount is absolute. In still other implementations, a click sequence including a complete chain of user interactions is evaluated. In yet another embodiment, a node tree is traversed as a user interacts with different aspects of an advertisement. Each node has an associated PPC payment amount. In some embodiments, the level of engagement is one factor among others used to determine an ultimate PPC payment amount (e.g., other factors can include a history of engagement for publishers).

FIG. 3 is an interaction diagram illustrating a communication sequence between components of the system of FIG. 1 for advertising on social media platforms with dynamic PPC payment amounts, according to one embodiment.

At interaction 301, the advertiser 110 sets up an advertisement account, and uploads PPC advertisements. In one embodiment, the advertiser 110 also configures an advertisement campaign, including making a specification of PPC payment amounts based on a level of engagement, for each advertisement. At interaction 311, the publisher 120 sets up a referral account on the advertisement server 120. At interaction 321, the publisher sets up a user profile on the social media platform 140. One or ordinary skill in the art will recognize that the above-listed interactions can occur in any order using various techniques not specifically described herein for conciseness.

At interaction 331, a code snippet, a copy of the advertisement, or other type of configuration data is sent from the advertisement server 120 to the publisher 130. At interaction 341, the publisher 130 posts content on the social media platform 140 that includes the advertisement (or reference thereto). In other embodiments, the publisher 130 provides banner space for dynamically served advertisements when a hosting web page is loaded.

At interaction 351, the social media platform 140 sends notification of a user interaction with an advertisement. In some embodiments, the social media platform 140 continues to send notifications about subsequent user interactions. In other embodiments, the social media platform 140 turns over tracking to an external device such as the advertisement server 120. At interaction, 361, the advertisement server 120 sends advertisement content to the social media platform 140 for display. In some examples, an advertisement include several different web pages, images, videos and the like that are traversed through with a series of clicks. The display can be inline of the social media platform 140 such as in a status feed or a posting. Alternatively the display can be a pop-up window, a banner on a web page, or any other suitable format.

At interaction 371, the advertisement sever 120 sends metrics or payment to the publisher 130. A payment can be made to the publisher 130 for the aggregate amount of PPC payment amounts that has accumulated over the last period.

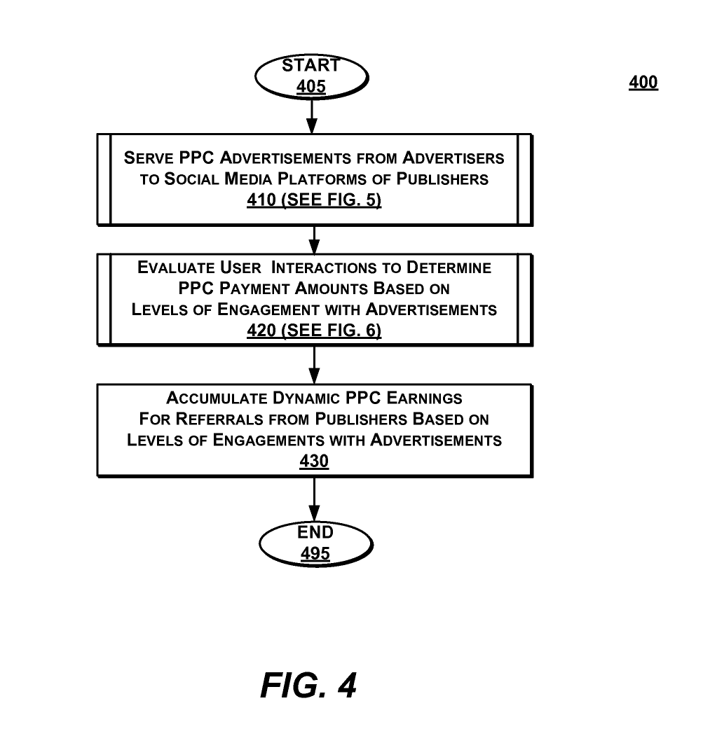

Methods for Dynamic PPC Payment Amounts (FIGS. 4-6)

FIG. 4 is a high-level flow diagram illustrating a method for advertising on social media platforms with dynamic PPC payments amounts, according to one embodiment. The method 400 can be implemented by, for example, the system 100 of FIG. 1.

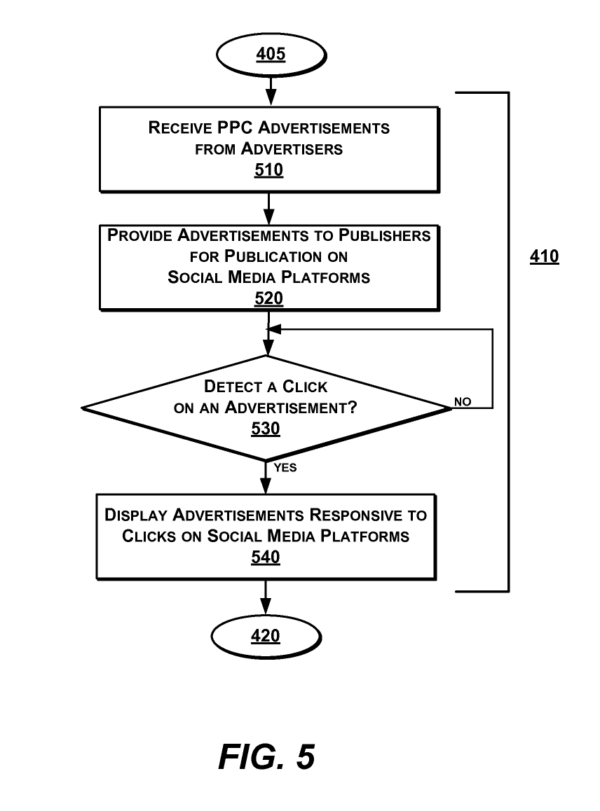

At step 410, PPC advertisements from advertisers are served to social media platforms of publishers. As detailed in FIG. 5, at step 510, PPC advertisements are received from advertisers. The advertiser can register for an account remotely or have one set up manually. A particular advertisement campaign can be configured by providing parameters such as PPC payment amounts, daily budgets, and termination points. In one embodiment, the PPC payment amounts are initial or default values that are dynamically modified at the time of an actual user interaction. In another embodiment, PPC payment amounts are all automatically determined without input from the advertiser. In still another embodiment, some PPC payment amounts can be hard wired such that no modification is permitted. At step 520, advertisements (or referrals such as a URL or publisher identification are provided to publishers for publication on social media platforms (can be provided by push or pull actions). At step 530, the advertisement is displayed responsive to clicks (or other user interactions) on social media platforms. For example, a URL can be clicked, or an image can be hovered over. In one embodiment, social media platforms send a notification of a user interaction along with a type or depth (e.g., a small purchase versus a large purchase, a top-level URL versus a deep-linked URL, a number of clicks, or a length of time) of user interaction. In another embodiment, a URL request or a post operation with a unique identifier is provided.

Returning to FIG. 4, at step 420, one or more user interactions are evaluated to determine PPC payment amounts based on levels of engagement with advertisements. Shown more particularly in FIG. 6, at step 610, a baseline level of engagement for user interactions with a particular advertisement is determined. At step 620, a level of engagement for a particular user interaction with an advertisement is determined. At step 630, the level of engagement of the particular user interaction is compared against the baseline level of engagement. In one embodiment, level of engagement is determined directly from the notification of a user interaction. The notification can be just a hyperlink or identifier. An advertisement server can track user interactions as notified from a social media platform, or as directly observed by URL requests for advertisement content. Alternatively, the notification can include other information that has been tracked at the social media platform, such a sequence of user interactions directly or indirectly related to the advertisement. For the baseline level of engagement, a median of clicks or exposure time or other statistical parameter can be determined and continually updated. In turn, PPC payment amounts can be updated accordingly.

At step 640, a PPC payment amount is determined based on the comparison. To do so, a table can be populated with user actions in a first column and dynamic PPC payment amounts in a second columns, such that each level of engagement can be individually specified. An advertisement can have many layers of user interaction, such as an initial click that exposes further information, registration of an account, consummation of a purchase, and so on. In one embodiment, the user interaction is thus defined by the action itself in addition to a traversal point of the user interaction in order to distinguish a user click on an initial advertisement impression versus a user click to initiate a text message chat with a live operator. Further, the PPC payment amounts for a particular user interaction with a particular advertisement can be determined, for example, at the time of the click, during a regular interval, or after the advertisement campaign ends.

Referring again to FIG. 4, at step 430, dynamic PPC earnings are accumulated for referrals from publishers, based on levels of engagement with advertisements. Once a user interaction with an individual advertisement is evaluated, the user interaction is logged and the corresponding PPC payment amount is added to a running total. Depending on the implementations, publishers can be paid weekly, monthly, quarterly or on-demand through PayPal, a check in the mail or any other available medium.

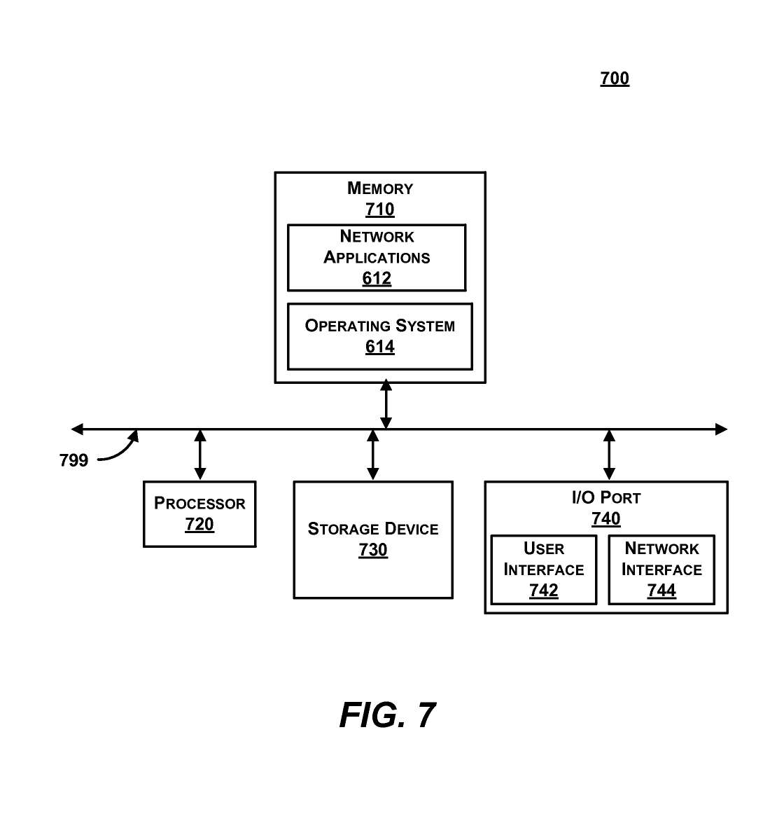

Generic Computing Device (FIG. 7)

FIG. 7 is a block diagram illustrating an exemplary computing device 700 for use in the system 100 of FIG. 1, according to one embodiment. The computing device 700 is an exemplary device that is implementable for each of the components of the system 100, including the advertiser 110, the advertisement server 120, the publisher 130, and the social media platform 140. Additionally, the computing device 700 is merely an example implementation itself, since the system 100 can also be fully or partially implemented with laptop computers, tablet computers, smart cell phones, Internet appliances, and the like.

The computing device 700, of the present embodiment, includes a memory 710, a processor 720, a hard drive 730, and an I/O port 740. Each of the components is coupled for electronic communication via a bus 799. Communication can be digital and/or analog, and use any suitable protocol.

The memory 710 further comprises network applications 712 and an operating system 714. The network applications 720 can include a web browser, a mobile application, an application that uses networking, a remote application executing locally (e.g., cloud-based), a network protocol application, a network management application, a network routing application, and the like.

The operating system 714 can be one of the Microsoft Windows® family of operating systems (e.g., Windows 97, 98, ME, Windows NT, Windows 2000, Windows XP, Windows XP x64 Edition, Windows Vista, Windows CE, Windows Mobile, Windows 7 or Windows 8), Linux, HP-UX, UNIX, Sun OS, Solaris, Mac OS X, Apple iOS (e.g., iOS7), Alpha OS, AIX, IRIX32, or IRIX64. Other operating systems or hardware interfaces can be used. Microsoft Windows is a trademark of Microsoft Corporation.

The processor 720 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 720 can be single core, multiple core, or include more than one processing elements. The processor 720 can be disposed on silicon or any other suitable material. The processor 720 can receive and execute instructions and data stored in the memory 710 or the hard drive 730.

The storage device 730 can be any non-volatile type of storage such as a magnetic disc, EEPROM, Flash, or the like. The storage device 730 stores code and data for applications.

The I/O port 740 further comprises a user interface 742 and a network interface 744. The user interface 742 can output to a display device and receive input from, for example, a keyboard. The network interface 744 connects to a medium such as Ethernet or Wi-Fi for data input and output. In one embodiment, the network interface 744 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11 e, 802.11 g, 802.11 i, 802.11 n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method for advertising on social media platforms with dynamic PPC (pay-per-click) payment amounts, the method comprising:
storing a plurality of advertisements in association with advertisers;
collecting statistical data regarding user interactions of a plurality of users with the plurality of advertisements to establish a baseline level of engagement for PPC payment amounts;
providing a particular advertisement from the plurality of advertisements, for publication on a social media platform accessed by a social publisher having a user profile on a social media platform;
receiving notification of a user interaction with the particular advertisement by a particular user in association with publication on the social media platform;
determining a level of engagement of the particular user with respect to the particular advertisement;
comparing, by a computing device, the level of engagement of the particular user against the baseline level of engagement for users from the plurality of users that interacted with the particular advertisement;
determining, by the computing device, a PPC payment amount for the referral based on the comparison, the PPC payment amount being a referral fee paid to the publisher for user interaction induced by the publication on the social media platform; and
storing the PPC payment amount for the particular user interaction with the particular advertisement in association with the social publisher.

2. The method of claim 1, wherein:
wherein collecting statistical data comprises continually collecting statistical data and continually updating the baseline level of engagement in order to provide a dynamic PPC payment amount.

3. The method of claim 1, wherein:
providing the particular advertisement comprises providing the particular advertisement for publication on a plurality of social media platforms accessed by the social publisher having a user profile on each of the plurality of social media platforms; and
receiving notification comprises receiving notification of the user interaction with the particular advertisement by the particular user in association with one of the plurality of social media platforms.

4. The method of claim 1, wherein:
providing the particular advertisement comprises providing a reference to the particular advertisement, the reference comprising at least one of a hyperlink, source code, a unique identifier of the publisher, or a unique identifier of the particular advertisement.

5. The method of claim 1, wherein:
providing the particular advertisement comprises providing the particular advertisement from the plurality of advertisements for publication on the social media platform accessed by a social publisher, wherein publication comprises a status update on the user profile of the social publisher that is distributed to contacts of the social publisher on the social media platform.

6. The method of claim 1, wherein:
providing the particular advertisement comprises providing the particular advertisement from the plurality of advertisements for publication on the social media platform accessed by a social publisher, wherein publication comprises distributing the reference to the particular advertisement to contacts of the social publisher with a content update in a user profile.

7. The method of claim 1, wherein determining the level of engagement comprises at least one of:
counting a number of clicks by the user in association with the particular advertisement;
measuring a length of exposure time for the advertisement in association with the particular user;
detecting a transaction by the user in association with the particular advertisement;
tracking activity of the particular user along a node tree having PPC payment amounts associated with each node; and
sensing an action by the particular user.

8. The method of claim 7, wherein the user interaction comprises at least one of:
a hover of a pointer over the reference to the particular advertisement;
a physical interaction with the reference to the particular advertisement;
a touch screen input corresponding to the reference to the; and
a click-through of the reference to the particular advertisement.

9. The method of claim 7, wherein the particular user interaction is customized to the social media platform or a type of publication.

10. The method of claim 1, further comprising:
accumulating a total amount of earnings for the publisher from PPC payment amounts for clicks induced by the publisher.

11. The method of claim 1, wherein the level of engagement is indicated by at least one of:
a type of interaction,
a depth of interaction,
a node on a traversal path, and
a click sequence.

12. The method of claim 1, wherein the level of engagement is one of multiple factors used to determine the PPC payment amount.

13. The method of claim 1, wherein a PPC payment amount for a first advertisement at a level of engagement is different from a PPC amount for a second advertisement at the same level of engagement.

14. The method of claim 1, wherein the PPC payment amount for the particular advertisement at a level of engagement for a first time is different than the PPC payment amount of the particular advertisement at the same level of engagement at a second time.

15. The method of claim 1, wherein the particular advertisement comprises at least one of:
at least one text string,
an image, and
a video.

16. The method of claim 1, wherein the social media platform comprises at least one of:
a social media web site,
a blog web site,
a chat; and
an e-mail group.

17. A non-transitory computer-readable medium storing instructions that, when executed by a processor, perform a computer-implemented method for advertising on social media platforms with dynamic PPC (pay-per-click) payment amounts, the method comprising:
storing a plurality of advertisements in association with advertisers;
collecting statistical data regarding user interactions of a plurality of users with the plurality of advertisements to establish a baseline level of engagement for PPC payment amounts;
providing a particular advertisement from the plurality of advertisements, for publication on a social media platform accessed by a social publisher;
receiving notification of a user interaction with the particular advertisement by a particular user in association with publication on the social media platform;
determining a level of engagement of the particular user with respect to the particular advertisement;
comparing the level of engagement of the particular user against the baseline level of engagement for users from the plurality of users that interacted with the particular advertisement;
determining a PPC payment amount for the referral based on the comparison, the PPC payment amount being a referral fee paid to the publisher for user interaction induced by the publication on the social media platform, and the PPC payment amount; and
storing the PPC payment amount for the particular user interaction with the particular advertisement in association with the social publisher.

18. An advertisement server to advertise on social media platforms with dynamic PPC (pay-per-click) payment amounts, the method comprising:
an account manager to associate a plurality of advertisements with advertisers;
a PPC advertisement database to storing the plurality of advertisements, the PPC advertisement database to collect statistical data regarding user interactions of a plurality of users with the plurality of advertisements to establish a baseline level of engagement for PPC payment amounts, and the PPC advertisement database to provide a particular advertisement from the plurality of advertisements, for publication on a social media platform accessed by a social publisher;
a PPC payment engine to receive notification of a user interaction with the particular advertisement by a particular user in association with publication on the social media platform, the PPC payment engine to determine a level of engagement of the particular user with respect to the particular advertisement, the PPC payment engine to compare the level of engagement of the particular user against the baseline level of engagement for users from the plurality of users that interacted with the particular advertisement, the PPC payment engine to determine a PPC payment amount for the referral based on the comparison, the PPC payment amount being a referral fee paid to the publisher for user interaction induced by the publication on the social media platform, and the PPC payment amount, and the PPC payment engine storing the PPC payment amount for the particular user interaction with the particular advertisement in association with the social publisher.

19. The method of claim 18, wherein the social media platform provides the account manager.
